(19) United States
(12) Patent Application Publication
(10) Pub. No.: US 2011/0244728 A1
(43) Pub. Date: Oct. 6, 2011

(54) UNIVERSAL SERIAL BUS CONNECTOR AND ADAPTOR OF THE CONNECTOR

(75) Inventors: Yi-Shun CHANG, Hsin-Chu (TW); Chun-Ping Wang, Hsin-Chu (TW)

(73) Assignee: Coretronic Corporation, Hsin-Chu (TW)

(21) Appl. No.: 12/985,110

(22) Filed: Jan. 5, 2011

(30) Foreign Application Priority Data
Mar. 30, 2010 (CN) 201010154837.3

(51) Int. Cl. H01R 31/06; H01R 24/00

(52) U.S. Cl. 439/628; 439/660

(57) ABSTRACT

A USB connector includes a body and first to fifth pins. The body has the same size as a type A USB connector. The first to fifth pins are disposed in the body. The first pin is adapted to be electrically connected to a power voltage. The second and the third pins are capable of transmitting a differential data signal. The fifth pin is adapted to be electrically connected to a reference voltage. The fifth pin and the fourth pin are a predetermined distance apart, so that the fourth pin is connected to the fifth pin via a ground pin of the four pins of a type A USB connector when the type A USB connector is connected to the USB connector. Furthermore, an adaptor of the USB connector is also provided.

### CROSS-REFERENCE TO RELATED APPLICATION

This application claims the priority benefit of CN application serial no. 201010154837.3, filed on Mar. 30, 2010. The entirety of the above-mentioned patent application is incorporated herein by reference and made a part of this specification.

### BACKGROUND

1. Field of the Invention

The invention relates to a connector and an adaptor, and particularly to a universal serial bus (USB) connector and an adaptor of the USB connector.

2. Description of Prior Art

The mini USB connector has been widely used in portable electronic devices. The mini USB connector includes five pins, and one of the pins is an identity identification pin. When a first electronic device with the mini USB connector is connected to a second electronic device, the first electronic device with the mini USB connector could automatically identify an identity of the second electronic device by determining the voltage level at the identity identification pin of the mini USB connector.

When the identity identification pin is at a high voltage level, the first electronic device with the USB connector determines the second electronic device to be a host (e.g., a computer). At the same time, the first electronic device with the USB connector sets itself at an external device operation mode for data transmission. When the identity identification pin is at a low voltage level, the first electronic device with the USB connector determines the second electronic device to be an external device, such as a USB flash drive or a USB bluetooth dongle. At the same time, the first electronic device with the USB connector sets itself at a host operation mode for data transmission.

The first electronic device with the mini USB connector could automatically identify the second electronic device to be a host or an external device. However, since most of the current electronic devices use the type A USB connector the electronic device with the mini USB connector needs to adopt an adaptor of USB connector to connect with the electronic device with the type A USB connector for data transmission.

Since the type A USB connector does not have any identity identification pin, a computer with the type A USB connector sets itself to be a host, and each of the portable electronic devices with the type A USB connector sets itself to be an external device. In other words, the first electronic device with the type A USB connector cannot automatically identify the second electronic device to be a host or an external device from the type A USB connector. Even if a USB controller has an identity identification function and the USB controller and the type A USB connector are adopted, the first electronic device still cannot automatically identify the second electronic device to be a host or an external device by the determining result of the signals transmitted by the pins of the type A USB connector.

Some manufacturers add a hardware switch or a software input/output pin to the electronic device with the USB connector to solve the above problems. However, adding an additional hardware switch may increase the volume of the electronic device with the type A USB connector. On the other hand, adding a software input/output pin may makes users to take a long time to learn the software, thereby causing inconvenient and inefficient. Furthermore, both of the aforementioned manners need to be performed by manual operation, so that the automation of the identity identification can not be achieved. In recent years, U.S. patent publication number US20040248472, Taiwan patent issue number M359067 and Dell company have provided some suggestions on improvement of the USB connector, however, there are no improvements on identity identification of the type A USB connector.

### BRIEF SUMMARY

The invention provides a USB connector, which allows the electronic device with the USB connector could automatically identify the identity of another electronic device.

The invention also provides an adaptor of the USB connector.

One of the embodiments of the invention provides a USB connector. The USB connector includes a body and first to fifth pins. The body has the same size as a type A USB connector. The first to fifth pins are disposed in the body. The first pin is adapted to be electrically connected to a power voltage. The second and the third pins are capable of transmitting a differential data signal. The fifth pin is adapted to be electrically connected to a reference voltage. The fifth pin and the fourth pin are a predetermined distance apart, so that the fourth pin could be electrically connected to the fifth pin via a ground pin of the four pins of the type A USB connector when the type A USB connector is connected to the USB connector.

One of the embodiments of the invention provides an adaptor of the USB connector. The adaptor includes a type A USB connector and a USB connector. The type A USB connector includes a first body and first to fourth pins. The first to fourth pins are disposed in the first body. The first pin is adapted to be electrically connected to a power voltage. The second and the third pins are capable of transmitting a differential data signal. The fourth pin is adapted to be connected to a reference voltage. The USB connector includes a second body and fifth to ninth pins. The second body has the same size as the first body. The fifth to ninth pins are disposed in the second body. The fifth pin is electrically connected to the first pin. The sixth pin is electrically connected to the second pin. The seventh pin is electrically connected to the third pin. The eighth pin is idle. The ninth pin is electrically connected to the fourth pin. The ninth pin and the eighth pin are a predetermined distance apart, so that the eighth pin could be electrically connected to the ninth pin via a ground pin of the four pins of another type A USB connector when the another type A USB connector is connected to the USB connector.

In the embodiments of the USB connector of the invention, the USB connector includes a body having the same size as the type A USB connector and five pins disposed in the body. The definition and function of four pins of the USB connector are the same as the four pins of the type A USB connector. An additional pin and a ground pin of the USB connector are a predetermined distance apart. Thus, the additional pin is electrically connected to the ground pin of the USB connector via the ground pin of the said another type A USB connector when the said another type A USB connector is connected to the USB connector. Therefore, the electronic device with the USB connector could identify the identity of another electronic device by determining the voltage variation at the additional pin.

In addition, one of the two connectors of the USB adaptor is a USB connector, and the other connector of the USB adaptor is a type A USB connector. Pins of the same definition of the two USB connectors are connected to each other, and the additional pin of the USB connector is idle. Thus, the electronic device with the USB connector can not only be connected to a type A USB connector via the adaptor, but also automatically identify identity.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a type A USB connector with a female body.

FIG. 2 is a schematic view of a type A USB connector with a male body.

FIG. 3 is a schematic view of an exemplary embodiment of a USB connector.

FIG. 4 shows that how an electronic device with a USB connector identifies identity.

FIG. 5 is a schematic view of an exemplary embodiment of a USB connector.

FIG. 6 shows that how two electronic devices identify identities using an adaptor.

FIG. 7 is a schematic view of an exemplary embodiment of a USB connector.

FIG. 8 is a schematic view of an exemplary embodiment of a USB connector.

### DETAILED DESCRIPTION

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Some direction expressions, such as up, down, left, right, before or after mentioned in the following embodiments only show directions of components in the following FIGs, and this does not mean to limit the invention.

In order to differentiate the USB connector of the invention from the type A USB connector, the following depicts the structure and the definition of pins of the type A USB connector.

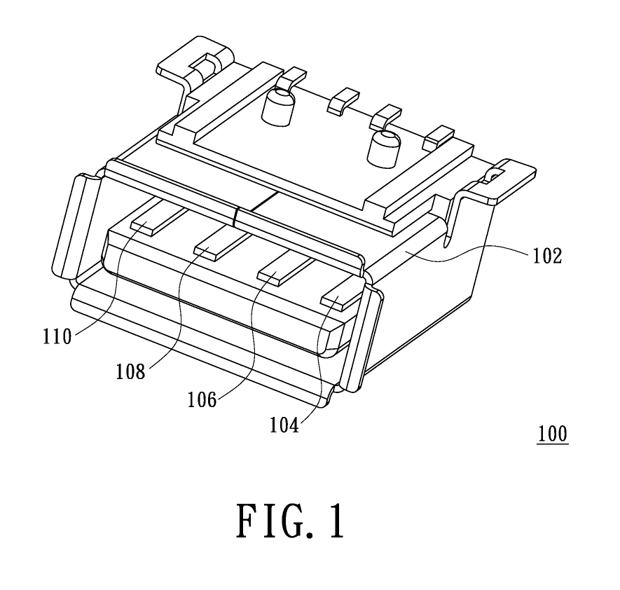

Referring to FIG. 1, a type A USB connector 100 including a female body 102 is shown. A power pin 104, a D− data transmitting pin 106, a D+ data transmitting pin 108 and a ground pin 110 are disposed in the body 102. The power pin 104 is adapted to be electrically connected to a power voltage. The D− data transmitting pin 106 and the D+ data transmitting pin 108 are capable of transmitting a differential data signal. The ground pin 110 is adapted to be electrically connected to a reference voltage (e.g., a ground voltage).

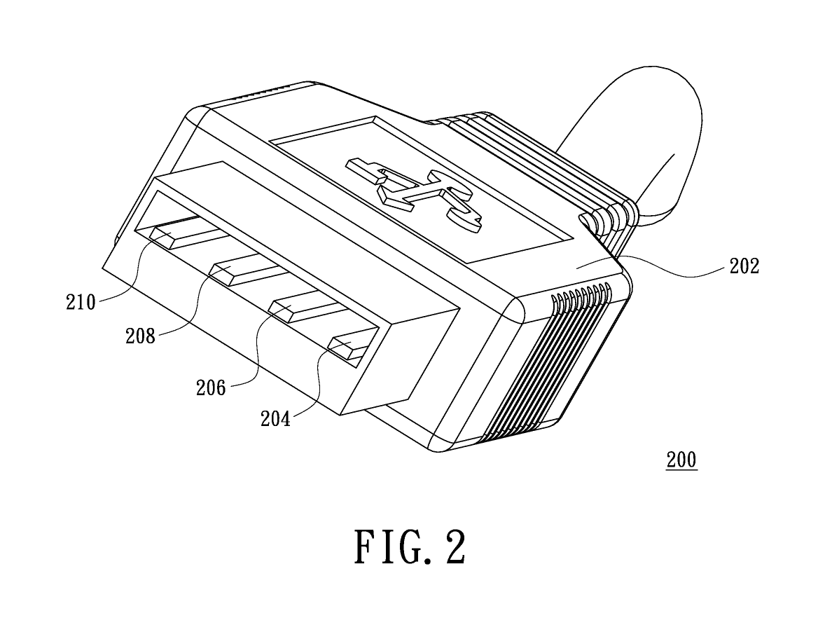

Referring to FIG. 2, a type A USB connector 200 including a male body 202 is shown. A power pin 204, a D− data transmitting pin 206, a D+ data transmitting pin 208 and a ground pin 210 are disposed in the body 202.

Since the structure of the body 102 matches with the structure of the body 202, the power pin 204, the D− data transmitting pin 206, the D+ data transmitting pin 208 and the ground pin 210 of the body 202 are electrically connected to the power pin 104, the D− data transmitting pin 106, the D+ data transmitting pin 108 and the ground pin 110 of the body 102 respectively when the type A USB connector 200 is connected to the type A USB connector 100. That is, pins of the same definition are electrically connected to each other. Thus, the two type A USB connectors could communicate with each other.

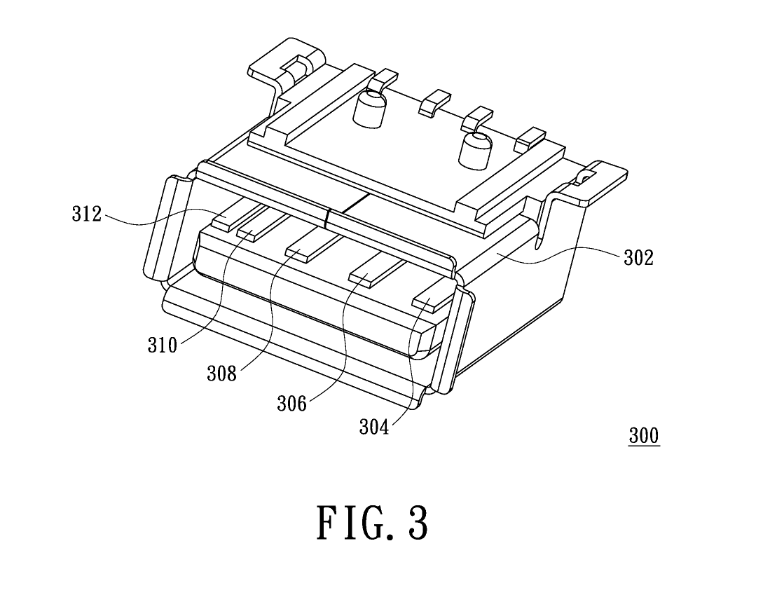

Referring to FIG. 3, a first embodiment of the USB connector of the invention is shown. A USB connector 300 includes a female body 302 having the same size as the type A USB connector. A power pin 304, a D− data transmitting pin 306, a D+ data transmitting pin 308, an additional pin 310 and a ground pin 312 are disposed in the body 302. The power pin 304 is adapted to be electrically connected to a power voltage. The D− data transmitting pin 306 and the D+ data transmitting pin 308 are capable of transmitting a differential data signal. The ground pin 312 is adapted to be electrically connected to a reference voltage (e.g., a ground voltage). The ground pin 312 and the additional pin 310 are a predetermined distance apart, so that the additional pin 310 is electrically connected to the ground pin 312 of the USB connector 300 via the ground pin of the type A USB connector when the type A USB connector is connected to the USB connector 300.

Thus, an electronic device with the USB connector 300 could identify the identity of another electronic device connected to the electronic device with the USB connector 300 by determining the voltage variation at the additional pin 310.

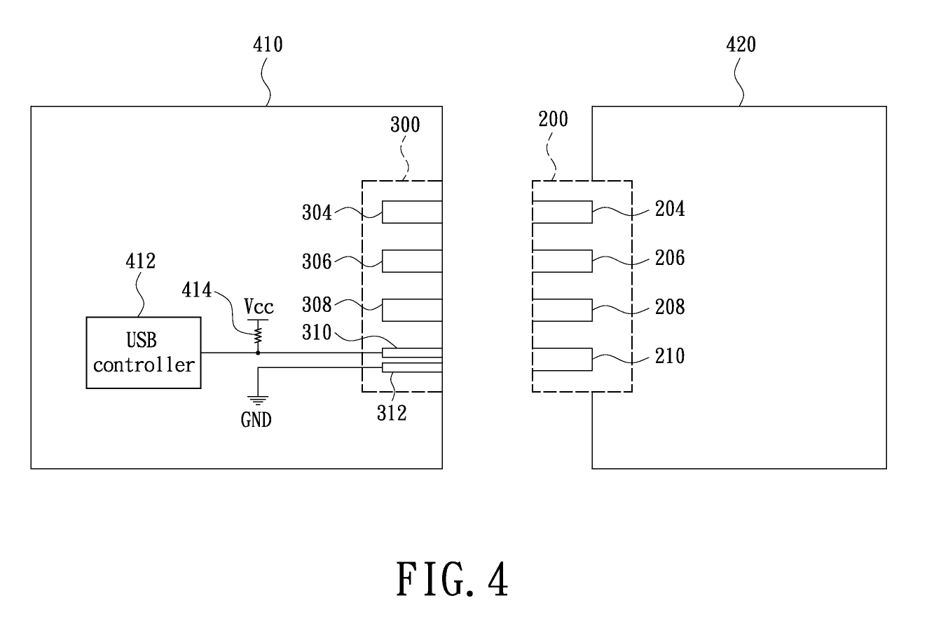

The following depicts how the electronic device with the USB connector automatically identifies the identity of another electronic device. Referring to FIG. 4, the electronic device 410 uses the USB connector 300 of FIG. 3. The additional pin 310 of the USB connector 300 is electrically connected to the USB controller 412 and is also electrically connected to a power voltage VCC via a resistor 414. The ground pin 312 of the USB connector 300 is electrically connected to a ground voltage GND. Connection relationships of the power pin 304, the D− data transmitting pin 306 and the D+ data transmitting pin 308 of the USB connector 300 are not shown in FIG. 4. The electronic device 420 uses the type A USB connector 200 of FIG. 2. Connection relationships of the power pin 204, the D− data transmitting pin 206, the D+ data transmitting pin 208 and the ground pin 210 of the USB connector 200 are not shown in FIG. 4.

When the USB connector 300 is not connected to the type A USB connector 200, the USB controller 412 detects that the additional pin 310 is at a high voltage level, and the USB controller 412 sets the electronic device 410 at an external device operation mode. When the USB connector 300 is connected to the type A USB connector 200, the additional pin 310 is electrically connected to the ground pin 312 of the USB connector 300 via the ground pin 210 of the type A USB connector 200. Thus, the voltage level at the additional pin 310 is equal to the voltage level of the ground GND. At the same time, the USB controller 412 detects that the additional pin 310 is at a low voltage level, and the USB controller 412 determines the electronic device 420 to be an external device. Furthermore, the USB controller 412 sets the electronic device 410 at a host operation mode for data transmission.

A second embodiment different from the first embodiment is that the positions of the additional pin 310 and the ground pin 312 of the USB connector 300 are interchanged, and the connection relationships of the additional pin 310 and the ground pin 312 are also interchanged.

A third embodiment depicts how to connect the USB connector 300 to the type A USB connector with a female body and how the electronic devices with the two USB connectors identify their identities.

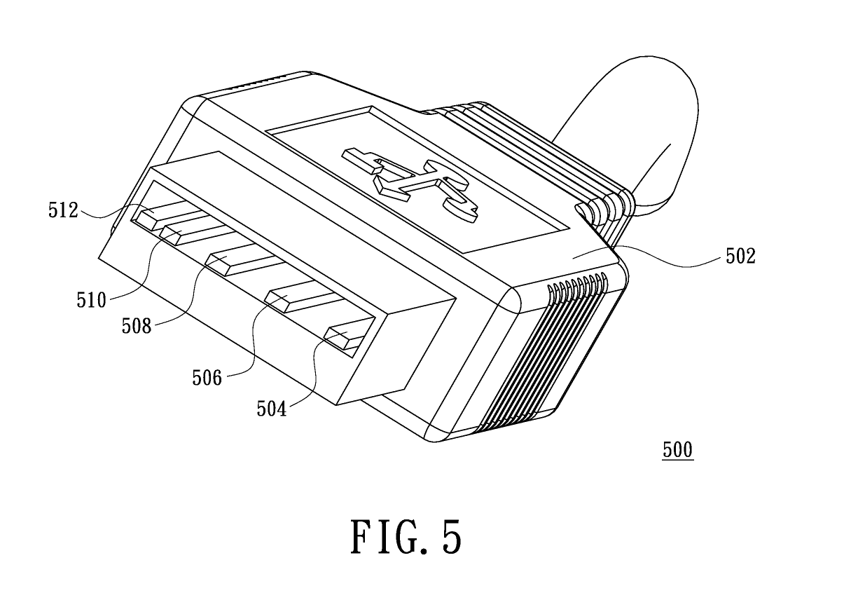

The USB connector 300 is connected to the type A USB connector with a female body via an adaptor. The adaptor has two USB connectors, one of the connectors is a type A USB connector with a male body (e.g., a type A USB connector 200 as shown in FIG. 2), and the other connector is a USB connector (e.g., a USB connector 500 as shown in FIG. 5).

Referring to FIG. 5, the USB connector 500 includes a male body 502 having the same size as the type A USB connector. A power pin 504, a D− data transmitting pin 506, a D+ data transmitting pin 508, an additional pin 510 and a ground pin 512 are disposed in the body 502. The positions of the five pins of the body 502 match with the positions of the five pins of the USB connector 300, so that the pins of the same definition are electrically connected to each other when the USB connector 500 is connected to the USB connector 300. That is, the ground pin 512 and the additional pin 510 are also a predetermined distance apart, so that the additional pin 510 of the USB connector 500 could be electrically connected to the ground pin 512 of the USB connector 500 via the ground pin of another type A USB connector when the another type A USB connector is connected to the USB connector 500.

In addition, the pins of the same definition of the two USB connectors of the adaptor are electrically connected to each other. The additional pin 510 of the USB connector 500 is idle (not connected to any pins).

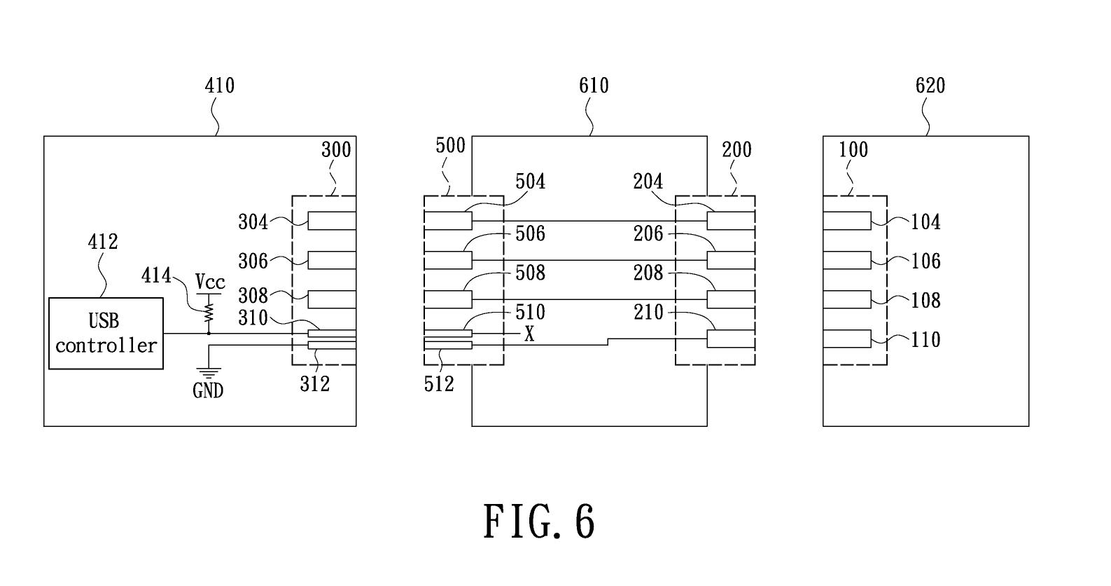

Thus, the USB connector 300 could be connected to the type A USB connector with a female body via the aforementioned adaptor. The following depicts how the electronic device with the USB connector 300 automatically identifies the identity of another electronic device with the type A USB connector. Referring to FIG. 6, the electronic device 410 uses the USB connector 300 of FIG. 3, the adaptor 610 uses the USB connector 500 of FIG. 5 and the type A USB connector 200 of FIG. 2, and the electronic device 620 uses the type A USB connector 100 of FIG. 1. The FIG. 6 uses the same component labels as the FIGS. 1-5.

When the electronic device 410 is connected to the electronic device 620 via the adaptor 610, the USB connector 300 is connected to the USB connector 500, and the type A connector 200 is connected to the type A USB connector 100. Since the additional pin 510 of the USB connector 500 is idle, the USB controller 412 could detect that the additional pin 310 of the USB connector 300 is at a high voltage level, and the USB controller 412 sets the electronic device 410 at an external device operation mode. Furthermore, since the electronic device 620 uses the type A USB connector 100, the electronic device 620 determines itself to be a host and sets itself at a host operation mode. Thus, the electronic devices 410 and 620 play different roles, so that data could be transmitted normally.

The electronic device with the USB connector can not only be connected to the type A USB connector via the aforementioned adaptor, but also automatically identify identity. The bodies of the two USB connectors of the adaptor have four combinations. The first combination is that the bodies of two USB connectors are female. The second combination is that the bodies of two USB connectors are male. The third combination is that the body of the USB connector is female, and the body of the type A USB connector is male. The fourth combination is that the body of the USB connector is male, and the body of the type A USB connector is female.

A fourth embodiment different from the third embodiment is that the positions of the additional pin 510 and the ground pin 512 are interchanged, and the connection relationships of the additional pin 510 and the ground pin 512 are also interchanged.

A fifth embodiment different from the third embodiment is that the bodies of the two USB connectors of the adaptor 610 could be directly connected to each other and could also be connected to each other via a cable.

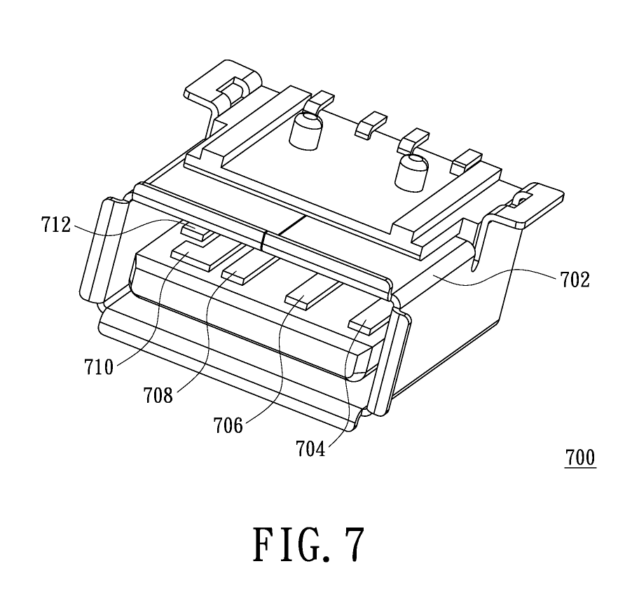

A sixth embodiment is shown in FIG. 7. The USB connector 700 includes a female body 702 having the same size as the type A USB connector. A power pin 704, a D− data transmitting pin 706, a D+ data transmitting pin 708, an additional pin 710 and a ground pin 712 are disposed in the body 702. The first terminals of the five pins are connected to the body 702. The length of the ground pin 712 is shorter than the lengths of the power pin 704, the D− data transmitting pin 706 and the D+ data transmitting pin 708. The additional pin 710 includes a bend portion, so that the second terminal of the additional pin 710 is in front of the second terminal of the ground pin 712. The second terminal of the additional pin 710 and the second terminal of the ground pin 712 are a distance apart.

Referring to FIG. 7, a seventh embodiment different from the sixth embodiment is that the additional pin 710 and the ground pin 712 could be interchanged. That is, the length of the additional pin 710 is shorter than the lengths of the power pin 704, the D− data transmitting pin 706 and the D+ data transmitting pin 708. The ground pin 712 includes a bend portion, so that the second terminal of the ground pin 712 is in front of the second terminal of the additional pin 710. The second terminal of the additional pin 710 and the second terminal of the ground pin 712 are a distance apart.

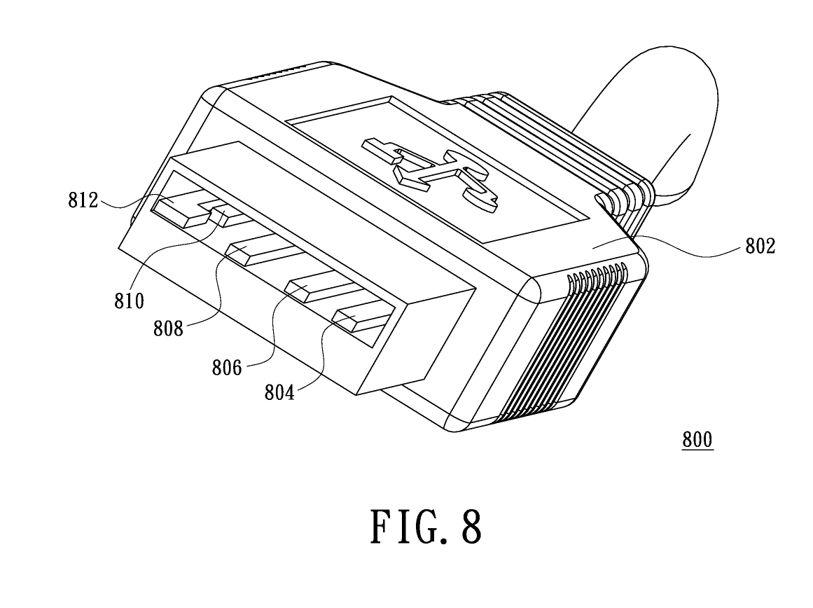

Referring to the FIG. 8, an eighth embodiment of the USB connector is shown. The USB connector 800 includes a body 802 having the same size as the type A USB connector. A power pin 804, a D− data transmitting pin 806, a D+ data transmitting pin 808, an additional pin 810 and a ground pin 812 are disposed in the body 802. The first terminals of the five pins are connected to the body 802. The length of the additional pin 810 is shorter than the lengths of the power pin 804, the D− data transmitting pin 806 and the D+ data transmitting pin 808. The ground pin 812 includes a bend portion, so that the second terminal of the ground pin 812 is in front of the second terminal of the additional pin 810. The second terminal of the additional pin 810 and the second terminal of the ground pin 812 are a distance apart.

A ninth embodiment different from the eighth embodiment is that the additional pin 810 and the ground pin 812 are interchanged. That is, the length of the ground pin 812 is shorter than the lengths of the power pin 804, the D− data transmitting pin 806 and the D+ data transmitting pin 808. The additional pin 810 includes a bend portion, so that the second terminal of the additional pin 810 is in front of the second terminal of the ground pin 812. The second terminal of the additional pin 810 and the second terminal of the ground pin 812 are a distance apart.

To sum up, in the embodiments of the invention, the USB connector includes a body having the same size as the type A USB connector and five pins disposed in the body. The definition and function of four pins of the USB connector are the same as the four pins of the type A USB connector. An additional pin and a ground pin of the USB connector are a predetermined distance apart. Thus, the additional pin could be electrically connected to the ground pin of the USB connector via the ground pin of the type A USB connector when the type A USB connector is connected to the USB connector. Therefore, the electronic device with the USB connector could identify the identity of another electronic device by determining the voltage variation at the additional pin.

In addition, one of the two connectors of the USB adaptor is a USB connector, and the other connector of the USB adaptor is a type A USB connector. Pins of the same definition of the two USB connectors are electrically connected to each other, and the additional pin of the USB connector is idle. Thus, the electronic device with the USB connector can not only be connected to a type A USB connector via the adaptor, but also automatically identify identity.

Therefore, the embodiments of the invention could automatically identify the identity of the electronic device without changing the definition and function of the existing pins and the existing communication protocol of the USB connector.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Each of the terms “first”, “third”, and “fourth” is only a nomenclature used to modify its corresponding elements. These terms are not used to set up the upper limit or lower limit of the number of pins in the invention.

What is claimed is:

1. An universal serial bus (USB) connector, comprising:
a body, having the same size as a type A USB connector;
a first pin, disposed in the body and adapted to be electrically connected to a power voltage;
a second pin, disposed in the body;
a third pin, disposed in the body, the third pin and the second pin capable of transmitting a differential data signal;
a fourth pin, disposed in the body; and
a fifth pin, disposed in the body and adapted to be electrically connected to a reference voltage;
wherein the fifth pin and the fourth pin are a predetermined distance apart, so that the fourth pin is electrically connected to the fifth pin via a ground pin of the four pins of another type A USB connector when the another type A USB connector is connected to the USB connector.

2. The USB connector as claimed in claim 1, wherein the fourth pin comprises a first terminal and a second terminal, the fifth pin comprises a third terminal and a fourth terminal, the first terminal of the fourth pin and the third terminal of the fifth pin are connected to the body, the length of the fifth pin is shorter than the lengths of the first to third pins, the fourth pin comprises a bend portion, so that the second terminal of the fourth pin is in front of the fourth terminal of the fifth pin, and the second terminal of the fourth pin and the fourth terminal of the fifth pin are a distance apart.

3. The USB connector as claimed in claim 1, wherein the fourth pin comprises a first terminal and a second terminal, the fifth pin comprises a third terminal and a fourth terminal, the first terminal of the fourth pin and the third terminal of the fifth pin are connected to the body, the length of the fourth pin is shorter than the lengths of the first to third pins, the fifth pin comprises a bend portion, so that the fourth terminal of the fifth pin is in front of the second terminal of the fourth pin, and the fourth terminal of the fifth pin and the second terminal of the fourth pin are a distance apart.

4. The USB connector as claimed in claim 1, wherein the body of the USB connector is female, and a body of the another type A USB connector is male.

5. The USB connector as claimed in claim 1, wherein the body of the USB connector is male, and a body of the another type A USB connector is female.

6. The USB connector as claimed in claim 1, wherein the reference voltage is a ground voltage.

7. An adaptor of an universal serial bus (USB) connector, comprising:
a type A USB connector, comprising:
a first body;
a first pin, disposed in the first body and adapted to be electrically connected to a power voltage;
a second pin, disposed in the first body;
a third pin, disposed in the first body, the third pin and the second pin being capable of transmitting a differential data signal;
a fourth pin, disposed in the first body and adapted to be electrically connected to a reference voltage; and
a USB connector, comprising:
a second body, having the same size as the first body;
a fifth pin, disposed in the second body and electrically connected to the first pin;
a sixth pin, disposed in the second body and electrically connected to the second pin;
a seventh pin, disposed in the second body and electrically connected to the third pin;
an eighth pin, disposed in the second body and idle;
a ninth pin, disposed in the second body and electrically connected to the fourth pin;
wherein the ninth pin and the eighth pin are a predetermined distance apart, so that the eighth pin is electrically connected to the ninth pin via a ground pin of the four pins of another type A USB connector when the another type A USB connector is connected to the USB connector.

8. The adaptor as claimed in claim 7, wherein the eighth pin comprises a first terminal and a second terminal, the ninth pin comprises a third terminal and a fourth terminal, the first terminal of the eighth pin and the third terminal of the ninth pin are connected to the second body, the length of the ninth pin is shorter than the lengths of the fifth to seventh pins, the eighth pin comprises a bend portion, so that the second terminal of the eighth pin is in front of the fourth terminal of the ninth pin, and the second terminal of the eighth pin and the fourth terminal of the ninth pin are a distance apart.

9. The adaptor as claimed in claim 7, wherein the eighth pin comprises a first terminal and a second terminal, the ninth pin comprises a third terminal and a fourth terminal, the first terminal of the eighth pin and the third terminal of the ninth pin are connected to the second body, the length of the eighth pin is shorter than the lengths of the fifth to seventh pins, the ninth pin comprises a bend portion, so that the fourth terminal of the ninth pin is in front of the second terminal of the eighth pin, and the fourth terminal of the ninth pin and the second terminal of the eighth pin are a distance apart.

10. The adaptor as claimed in claim 7, wherein the first body is directly connected to the second body.

11. The adaptor as claimed in claim 7, wherein the first body is connected to the second body via a cable.

12. The adaptor as claimed in claim 7, wherein the second body of the USB connector is male, the first body of the type A USB connector is male, and a body of the another type A USB connector is female.

13. The adaptor as claimed in claim 7, wherein the second body of the USB connector is female, the first body of the type A USB connector is female, and a body of the another type A USB connector is male.

14. The adaptor as claimed in claim 7, wherein the second body of the USB connector is male, the first body of the type A USB connector is female, and a body of the another type A USB connector is female.

15. The adaptor as claimed in claim 7, wherein the second body of the USB connector is female, the first body of the type A USB connector is male, and a body of the another type A USB connector is male.

16. The adaptor as claimed in claim 7, wherein the reference voltage is a ground voltage.
